(19) United States
(12) Patent Application Publication
(10) Pub. No.: US 2004/0121789 A1
(43) Pub. Date: Jun. 24, 2004

(54) Method and apparatus for communicating information in a global distributed network

(76) Inventor: Teddy Lindsey, San Diego, CA (US)

Correspondence Address: Qualcomm Incorporated, Patents Department, 5775 Morehouse Drive, San Diego, CA, 92121-1714, US

(21) Appl. No.: 10/329,195

(22) Filed: Dec. 23, 2002

(51) Int. Cl. H04B 7/00; H04Q 7/20

(52) U.S. Cl. 455/517

(57) ABSTRACT

A method and apparatus provides for receiving information from a first endpoint, receiving information from a second endpoint, and forwarding the information received first to a destination endpoint. The method and apparatus also provides for receiving a request for information from an access device and delivering the information to the access device, if the information is available in a format suitable for delivery to the access device. If the information is unavailable, the method and apparatus further provides for accessing the requested information from a destination endpoint, transforming the received information to a format suitable for delivery to requesting access device, and delivering the information to the requesting access device. The method and apparatus also provides for accessing information from an endpoint, transforming the information into a suitable format, and delivering the transformed information to an access device, if the access device is ready to receive information, but queuing the transformed information, if the access device is not ready to receive information.

### FIELD

The present invention relates to communicating information in a global distributed network, such as the Internet. More specifically, the present invention relates to methods and apparatus for efficiently communicating information among a plurality of information providers and a plurality of remote access devices in a global distributed network.

### BACKGROUND

When a user attempts to access information from a target application or server in a global distributed network, such as the Internet, a web server provides the necessary interface between the user's access device and the target application or server. However, the web server is browser and/or device specific. That is, the web server has to be customized for the specific browser running on the user's specific access device, which may be a wireless phone, a portable computer, or a personal data assistant (PDA). Moreover, the target application or server that provides the information has to know about the specific remote access device type that a user will use to access the information.

There is a need, therefore, for a device-independent web server that supports a plurality of remote access device types as well as a plurality of information providers. There is also a need for a highly extensible, scalable infrastructure that is easy to develop and maintain.

### SUMMARY

The disclosed embodiments provide novel and improved methods and apparatus for providing information from a plurality of origin endpoints to a destination endpoint. The method includes the steps of: receiving information from a first origin endpoint, the information identifying the first origin end point, a version of the information at the first origin endpoint, and an endpoint that last changed the information; receiving the information from a second origin endpoint, the information identifying the second origin end point, a version of the information at the second origin endpoint, and an endpoint that last changed the information; and forwarding the information received first from either the first origin endpoint or the second origin endpoint to the destination endpoint. The method also includes updating a version of the information and the endpoint that last changed the information at the destination endpoint, based on the information that is forwarded to the destination endpoint.

In another aspect, a method for providing information to one of a plurality of access devices includes: receiving a request for the information from one of the access devices and delivering the information to the requesting access device, if the information is available in a format suitable for delivery to the requesting access device. If the information is unavailable, the method further includes accessing the requested information from a destination endpoint, transforming the received information to a format suitable for delivery to the requesting access device, and delivering the information to the requesting access device.

In another aspect, a method for providing information to one of a plurality of access devices includes the steps of accessing the information from an endpoint; transforming the information into a plurality of formats, each format suitable for delivery to one of the access devices; and delivering the transformed information to one of the access devices, if the access device is ready to receive the transformed information. If the access device is not ready to receive the transformed information, the method further includes queuing the transformed information.

In another aspect, an apparatus for providing information to one of a plurality of access devices comprises a memory unit, a receiver, a transmitter, and a processor communicatively coupled with the memory unit, the receiver, and the transmitter. The processor is capable of executing instructions to carry out the above-mentioned methods.

### BRIEF DESCRIPTION OF THE DRAWINGS

The features and advantages of the present invention will become more apparent from the detailed description of disclosed embodiments set forth below when taken in conjunction with the drawings, and wherein:

FIG. 1 illustrates an arrangement for interfacing a plurality of remote access devices to a plurality of information providers, according to an embodiment;

FIG. 2 illustrates an arrangement for interfacing a plurality of remote access devices to a plurality of information providers, according to another embodiment;

FIG. 3 illustrates an embodiment for a web server infrastructure and a remote access device; and

FIG. 4 through FIG. 9 illustrate an event propagation scheme.

### DETAILED DESCRIPTION

Before several embodiments are explained in detail, it is to be understood that the scope of the invention should not be limited to the details of the construction and the arrangement of the components set forth in the following description or illustrated in the drawings. Also, it is to be understood that the phraseology and terminology used herein is for the purpose of description and should not be regarded as limiting.

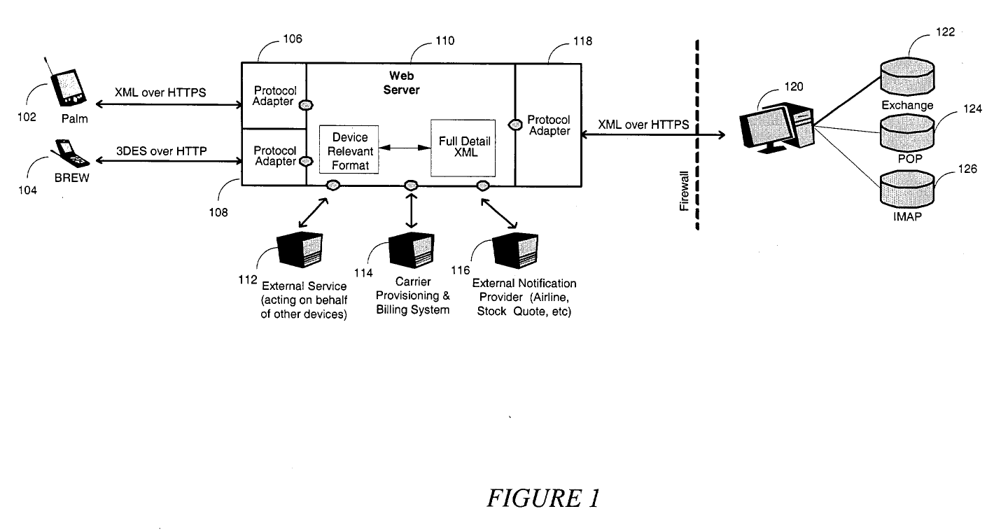

FIG. 1 illustrates an arrangement for interfacing a plurality of remote access devices 102, 104 to information providers (warehouses) 122, 124, 126 through an application 120, according to one embodiment. Application 120 may run on a computer that may be in communication with a web server 110 through a protocol adapter 118. Remote access devices 102, 104 may be also in communication with the web server 110 through protocol adapters 106, 108, respectively.

The remote access devices include a personal digital assistant (PDA), e.g., PALM 102, and a wireless device. 104. Wireless device 104 may be enabled with binary runtime environment for wireless (BREW). The remote access devices may also include a portable computer, a video camera, and/or a digital still camera. Each access device runs its own specific browser for accessing a destination web site, and each access device communicates information using specific data encryption and/or compression protocols. For example, PALM device 102 uses extensible markup language (XML), which may be encrypted with data encryption standard (DES), triple data encryption standard (3DES) or advanced encryption standard (AES), over hypertext transfer protocol (HTTP) or hypertext transfer protocol, secure (HTTPS), and the wireless device 104 uses DES or 3DES over HTTPS or HTTP protocol.

Information providers (warehouses), which include MICROSOFT EXCHANGE 122, Post Office protocol mail servers (POP) 124, and Internet message access protocol (IMAP) servers 126 provide raw information, which are managed by application 120. Application 120 publishes and manipulates information, e.g., video, audio, image, and/or data, in device-independent generic format, e.g., “full-detail XML,” without specific knowledge of what type of remote access devices my request for the information. The remote access device may be any device that is capable of making a connection to the Internet.

Application 120 and the web server 110 communicate signaling and data via a web service interface, such as simple object access protocol (SOAP) or XML, which may be encrypted with 3DES, DES or AES, over HTTP or HTTPS protocol. Remote access devices 102, 104 communicate requests and data via a web service interface, such as SOAP, XML, which may be encrypted with 3DES, DES or AES, over HTTPS or HTTP protocol, DES or 3DES over HTTP or HTTPS protocol, and/or AES over HTTP protocol.

Web server 110 is in communication with external service 112, which may be acting on behalf of other devices in the network. Web server 110 is also in communication with service provider provisioning and/or billing systems 114, for example. Web server 110 is further in communication with external notification provider 116, providing information such as airline information, e.g., schedules, fares, reservation, and/or stock quote information. A web server includes a device that provides information to a consuming client. The information served by the web server may take the form of user interface markup, such as HTML or WML, or the information may be in the form of remote functionality, such as XML data invoked by SOAP methods over HTTP. A web server includes a device that can serve as a content server or as an application server.

Protocol Adapters

While the services of web server 110 may be provided through SOAP web service interface, not all external devices may be capable of invoking such interface. Small modules of code called protocol adapters are provided that interface a specific remote access device or application layer 120 to web server 110. The protocol adapters provide the freedom to expose many different interfaces, tailored for the needs of a wide range of remote devices, without having to change the core web server or standardize on a lowest common denominator protocol. The protocol adapters are also capable of translating security and encryption for remote access devices, including those devices that lack transport-level security. The protocol adapters may translate device-specific requests into standardized requests and, conversely, translate general responses into device-specific responses. It should be noted that protocol adapters are optional elements and may be used in conjunction with a device that may be incapable of invoking web services over secure transports and/or using low bandwidth connections.

Protocol adapters 106, 108 receive requests from the respective remote access devices 102, 104 for specific information, e.g., email, contact, calendar, etc., and query the web server 110 for the requested information. The protocol adapters may de-encrypt and/or decompress the requests if necessary. If the requested information is available at the web server 110, the protocol adapters access the requested information from web server 110, and provide the information to the respective remote access device. The protocol adapters may encrypt and/or compress the requested information for transmission to the respective remote access devices. Protocol adapter may transform the received information to a format suitable for delivery to a requesting device.

Web server 110 receives a request for information from one of the remote access devices 102, 104, sends an acknowledgement to the requesting remote access device, and provides the requested information to the requesting remote access device, if the requested information is available at the web server 110. However, if the requested information is not available at the web server 110, the web server 110 sends the request to the application 120, and waits for the application 120 to process the request and send the requested information to the web server 110.

Web server 110 receives information from application 120 and forwards the requested information to the requesting remote access device, if such device is ready to access the requested information. Web server 110, after receiving information from application 120 may queue the information, which may be accessed by one or more remote access devices 102, 104 when such devices are ready to access the information.

Information generators or information warehouses 122, 124, 126 provide information to the application 120. Application 120 manipulates and publishes information, which may be accessed by any one of the remote devices 102, 104. Application 120 may be device independent, meaning that the published information is in a generic device-irrelevant format that is generated irrespective of the types of the remote devices in use.

The information published by the application 120 is communicated with the web server 110 over an XML over HTTPS link through simple object access protocol (SOAP). Application 120 may also be interfaced with the web server through protocol adapter 118.

Web server 110 provides web service interfaces and transforms the device-irrelevant information that it receives from application 120 to specific device-relevant formats, each suitable for delivery to a specific access device, including local and remote access devices. Alternatively, web server 110 receives the requested information from application 120 in device-irrelevant format and transforms it to a format that is suitable for delivery to a requesting remote access device.

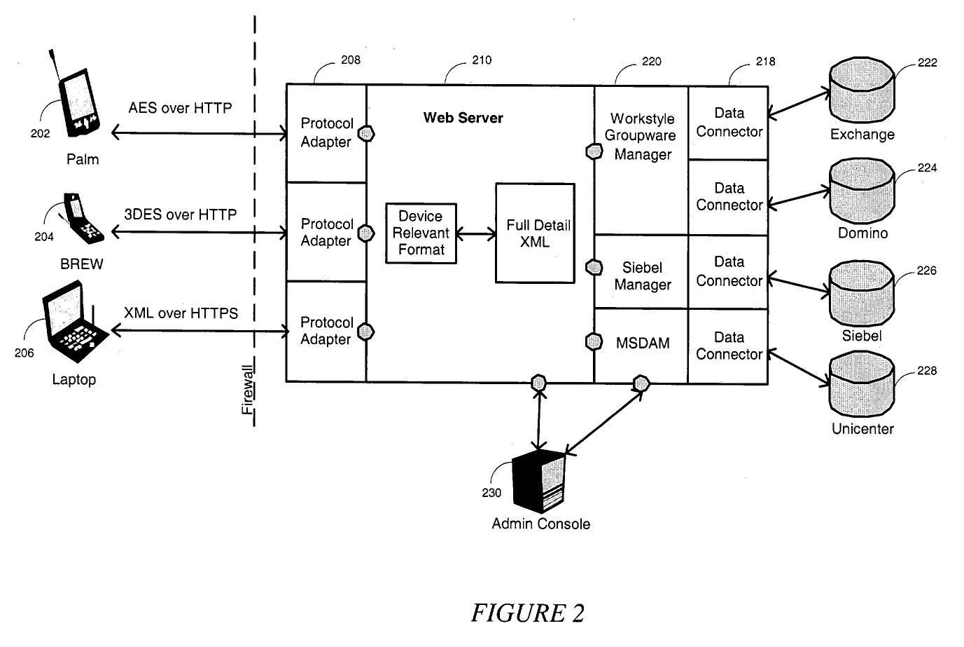

FIG. 2 illustrates an alternative arrangement for interfacing a plurality of remote access devices 202, 204, 206 to information providers (warehouses) 222, 224, 226, 228 through an application layer 220, according to one embodiment. Application layer 220 may be in communication with information providers 222, 224, 226, 228 through a data connector layer 218. Data connector layer 218 takes information from the information providers 222, 224, 226, 228 and passes the information to application layer 220 using one of several schemas, e.g., XML schema.

Remote access devices 202, 204, 206 may be also in communication with the web server 210 through protocol adapter layer 208. Web server 210 is also in communication with administration console 230 for managing the web server 210 and/or application layer 220. The remote access devices include a personal digital assistant (PDA), e.g., PALM 202, a wireless device 204, and laptop computer 206. Wireless device 204 may be enabled with binary runtime environment for wireless (BREW). The remote access devices may also include a video camera and/or a digital still camera. As noted before, the remote device may be any device capable of making a connection to the Internet. For example, PALM device 202 uses advanced encryption standard (AES) over hypertext transfer protocol, secure (HTTPS) or hypertext transfer protocol (HTTP), the wireless device 204 uses data encryption standard (DES) or triple data encryption standard (3DES) over HTTP or HTTPS, and the portable computer 206 uses extensible markup language (XML), which may be encrypted with DES, 3DES or AES, over HTTPS or HTTP. 1

Information providers (warehouses), which may include MICROSOFT EXCHANGE® 222, DOMINO® 224, SIEBEL® 226, and UNICENTER® 228, are managed by application layer 220 through data connector layer 218. Application layer 220 publishes and manipulates information, e.g., video, audio, image, and/or data, in device-independent generic format, e.g., “full-detail XML,” without specific knowledge of what type of remote access devices my request for the information. Application layer 220 include WORKSTYLE® groupware manager, SIEBEL® manager, and mobile software delivery asset management (MSDAM®) solution, or any other application layer that performs specific functionality.

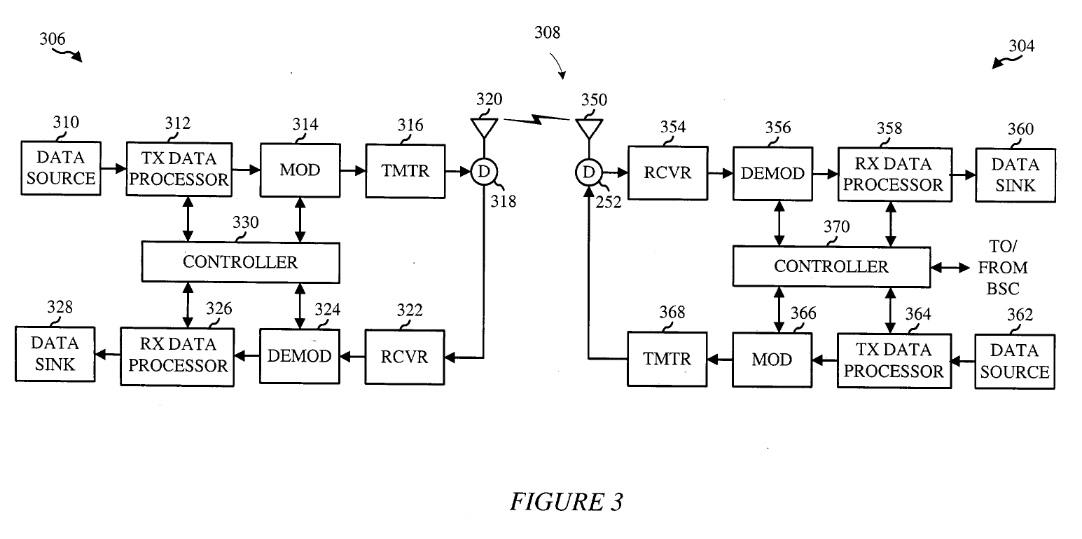

FIG. 3 is a simplified block diagram of an embodiment of web server infrastructure 304 and remote access device 306, which are capable of implementing various disclosed embodiments. For a particular communication, voice data, packet data, and/or messages may be exchanged between web server infrastructure 304 and remote access device 306, via an air interface 308. Various types of messages may be transmitted, such as messages used to establish a communication session between the web server infrastructure and remote access device, registration and paging messages, and messages used to control a data transmission (e.g., power control, data rate information, acknowledgment, and so on). Some of these message types are described in further detail below.

For the reverse link, at remote access device 306, voice and/or packet data (e.g., from a data source 310) and messages (e.g., from a controller 330) are provided to a transmit (TX) data processor 312, which formats and encodes the data and messages with one or more coding schemes to generate coded data. Each coding scheme may include any combination of cyclic redundancy check (CRC), convolutional, turbo, block, and other coding, or no coding at all. The voice, packet data, and messages may be coded using different schemes, and different types of messages may be coded differently.

The coded data is then provided to a modulator (MOD) 314 and further processed (e.g., covered, spread with short PN sequences, and scrambled with a long PN sequence assigned to the user terminal). The modulated data is then provided to a transmitter unit (TMTR) 316 and conditioned (e.g., converted to one or more analog signals, amplified, filtered, and quadrature modulated) to generate a reverse link signal. The reverse link signal is routed through a duplexer (D) 318 and transmitted via an antenna 320 to web server 304.

At web server infrastructure 304, the reverse link signal is received by an antenna 350, routed through a duplexer 352, and provided to a receiver unit (RCVR) 354. Alternatively, the antenna may be part of the wireless operator network, and the connection between the antenna and the web server may be routed through the Internet. Web server infrastructure 304 may receive information and status information from remote access device 306. Receiver unit 354 conditions (e.g., filters, amplifies, down converts, and digitizes) the received signal and provides samples. A demodulator (DEMOD) 356 receives and processes (e.g., despreads, decovers, and pilot demodulates) the samples to provide recovered symbols. Demodulator 356 may implement a rake receiver that processes multiple instances of the received signal and generates combined symbols. A receive (RX) data processor 358 then decodes the symbols to recover the data and messages transmitted on the reverse link. The recovered voice/packet data is provided to a data sink 360 and the recovered messages may be provided to a controller 370. Controller 370 may include instructions for receiving information, updating information, queuing information, sending information, transforming information from one format to another, encrypting and/or decrypting information, and compressing and/or decompressing information. The processing by demodulator 356 and RX data processor 358 are complementary to that performed at remote access device 306. Demodulator 356 and RX data processor 358 may further be operated to process multiple transmissions received via multiple channels, e.g., a reverse fundamental channel (R-FCH) and a reverse supplemental channel (R-SCH). Also, transmissions may be simultaneously from multiple mobile stations, each of which may be transmitting on a reverse fundamental channel, a reverse supplemental channel, or both.

On the forward link, at web server infrastructure 304, voice and/or packet data (e.g., from a data source 362) and messages (e.g., from controller 370) are processed (e.g., formatted and encoded) by a transmit (TX) data processor 364, further processed (e.g., covered and spread) by a modulator (MOD) 366, and conditioned (e.g., converted to analog signals, amplified, filtered, and quadrature modulated) by a transmitter unit (TMTR) 368 to generate a forward link signal. The forward link signal is routed through duplexer 352 and transmitted via antenna 350 to remote access device 306. Forward link signals include paging signals.

At remote access device 306, the forward link signal is received by antenna 320, routed through duplexer 318, and provided to a receiver unit 322. Receiver unit 322 conditions (e.g., down converts, filters, amplifies, quadrature modulates, and digitizes) the received signal and provides samples. The samples are processed (e.g., despreaded, decovered, and pilot demodulated) by a demodulator 324 to provide symbols, and the symbols are further processed (e.g., decoded and checked) by a receive data processor 326 to recover the data and messages transmitted on the forward link. The recovered data is provided to a data sink 328, and the recovered messages may be provided to controller 330. Controller 330 may include instructions for requesting for information, receiving information, encrypting and/or decrypting information, and compressing and/or decompressing information.

End Points

The term “end point” is used in the present application to represent a device, a server, or a service working on behalf of a device. Each end point is uniquely identified within the system by an identifier, e.g., “End_Point_Id,” which is assigned by the web server 110, 210, or another entity in the network, during provisioning process, as explained in more detail later herein.

It should be noted that the provider of groupware information is often referred to as the “master” and may be a desktop computer or an enterprise groupware provider. The term “master” is used to delineate the authoritative controller or repository of information, e.g., a corporate database server, such as 122, 124, 126, in FIG. 1, for example.

End Point Provisioning

During provisioning process, each end point or device that starts up for the first time sends a request to the web server 110 or 210 to obtain its End_Point_Id. The request includes a command envelope called “Provision Request” and causes the web server 110 or 210 to send back a “Provision_Response,” which includes the End_Point_Id. The End_Point_Id may be stored and used to uniquely identify the provisioned end point.

When a user has multiple devices associated with her account, the system provides web-based management interfaces for the multiple devices. The web-based management interface creates a “slot” for each device and assigns a unique End_Point_Id to each device, upon user's request. When a new device first communicates with the web server, the new device is assigned with its End_Point_Id, when it makes the initial Provision_Request. When a device is reset or when client software is reinstalled, the device makes a Provision₁₃ Request upon initial startup.

Item Identifiers

The system may attach a unique system identifier to each item, such as a request, a response, or an event. This may be different from the unique local identifier that may be used within a device database or messaging application programming interface (MAPI) store. Each endpoint may maintain a table that maps its local identifier to its system identifier. The system identifier may be referred to as “Item_Id.” In order for end points to be able to generate a guaranteed unique Item_Id, the Item_Id includes the End_Point_Id combined with an incremental value. This value is very similar in function to a globally unique identifier (GUID), but it is more compact and is unique within the “universe” of a particular user and her associated end points. For example, a device with End_Point_Id of 123 generates a new Item_Id by incrementing the current value in its local store, e.g., 89, and combining the newly incremented value of 90 with the End_Point_Id of 123. Thus, the generated Item_Id would be “123-90.”

Server-Side Data Transcoding

Since the data representation schemas that the application layer uses may be very rich and/or somewhat verbose, such data schemas may be not ideal for use on bandwidth-constrained wireless devices. An end point communicates with the web server in a specific format that reflects the specific capabilities of that end point. The rich-data schema used by the application layer is referred to as “Full-Detail Schema” and the terse-data schema used by web server is referred to as the “End-Point-Relevant Schema”. The web server translates the device-irrelevant full-detail-schema information that it receives from the application layer into device-relevant formats before they are queued or sent to a requesting access device. This transformation works for both the send and receive operations such that a specific end point does not need to understand the full-detail schema.

Event Propagation

Event propagation is the mechanism by which events that happen on one specific end point are selectively communicated to other end points. During event propagation, the master sends update requests to the web server, whenever changes occur, and tags the updated requests with a reference as to who originated the change. The web server may not propagate updates to end points that originally originated a particular event; a “selective broadcast” prevents an originator from getting the same event that it originated. A command envelope contains an element called the Originator_End_Point_Id, identifying the endpoint that originated a particular command envelope. The meaning of the Originator_End_Point_Id element is significantly different in point-to-point communications, where an originator end point may request that any responses be only sent to the originator end point. Communications between end points may occur in a number of ways, the most common being a broadcast from one end point to all other end points, or as point-to-point communication between two individual end points. The event propagation model described herein allows for both cases and includes a mechanism that prevents unnecessary communications, such as the case in which an end point which originates a broadcast should not itself receive that same broadcast. This is managed by tracking which end point originates a message so that should a broadcast become necessary, the broadcast will be sent to everyone except the originator.

Concurrency Resolution

In an asynchronously connected system, such as one shown in FIG. 1 and FIG. 2, the problem of concurrency resolution may arise. Concurrency resolution refers to the case that concurrent changes are made at more than one endpoints and the endpoints need to be in sync with respect to the changes. Concurrency resolution is based on a change tracking system, which may be based on the following assumptions, for example:

When in doubt, the master, e.g., the authoritative data store always wins.

When concurrent messages are in transit, first one received by the master wins.

Some changes may be lost but all end points will eventually have the same final state.

An item of information, e.g., a request, a response, and/or an event, is tracked based on the item's Item_Id, the last end point that made a change to the item, which may be identified by “Change₁₃ End_Point_Id,” and a version or change number, e.g., “Change_Number,” associated with the item. When the system works asynchronously, end points may not be able to get an authoritative confirmation on whether a change was successful, but they may make an optimistic assumption and “post increment” their Change Numbers and update their Change End Point_Ids for the item in question. The Change Number and Change_End_Point_Id, which are attached to an item, refer to the “last known authoritative” values and may be recorded as the last official change values. Furthermore, the post incrementing of the Change₁₃ Number and the updating of the Change_End_Point_Id are performed by an end point after the end point has completed a successful change operation.

To effectuate a change, the receiving endpoint checks an inbound item to verify that the Item-Id, Change_Number, and Change_End_Point_Id of the incoming item are the same as its authoritative Item_Id, Change_Number, and Change_End_Point_Id. If the values match, the receiving end point's Change₁₃ Number is incremented by 1 and the receiving end point's Change_End₁₃ Point_Id is modified to reflect that of the endpoint that initiated the change. However, if the values do not match, the inbound item is ignored and the corresponding changes are effectively lost. When successful update messages are sent out to the end points that did not win the concurrency battle, such end points accept the update, since the master is assumed to always wins. Newly created items are initialized with a Change_Number of 1.

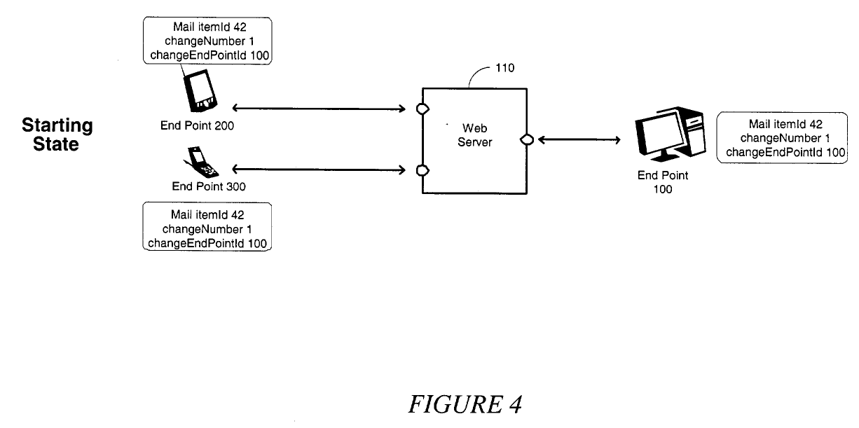

FIG. 4 through FIG. 9 illustrate a concurrency resolution process, according to one embodiment. The figures show a scenario in which concurrent changes are made at two end points and update requests are sent so that all end points end up in the same final state. FIG. 4 shows the starting state that all endpoints are in the same initial state, e.g., an item of “Mail” has Item-Id of 42, a Change_Number of 1, and that the item was last changed by an endpoint having the Change_End_Point_Id of 100.

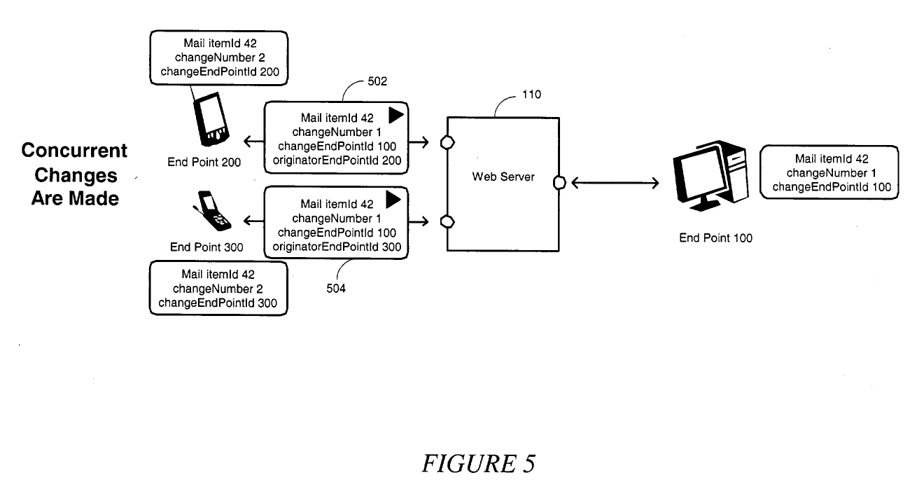

FIG. 5 shows a scenario where changes occur to the Mail-Item 42 by both “End Point 200” and “End Point 300” at the same time. Both end points “post increment” their Change_Numbers to 2, to reflect the state they optimistically believe the master will eventually have and both end points send update requests 502, 504 to the web server 110. It is noted that the update requests 502, 504 use their respective last known authoritative Change_Numbers and Change-End-Point-Ids. Each of the update requests 502, 504 also includes an “Originator-End-Point-Id,” which identifies the respective endpoint that has initiated the change.

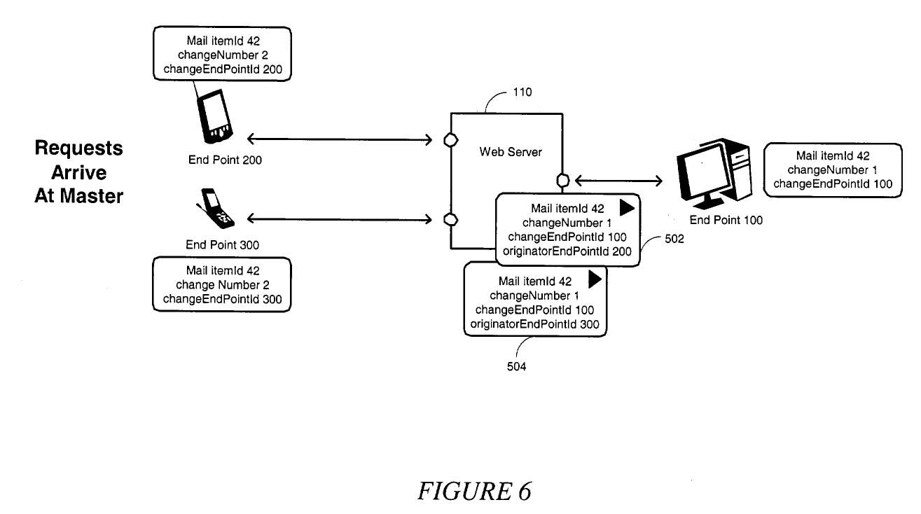

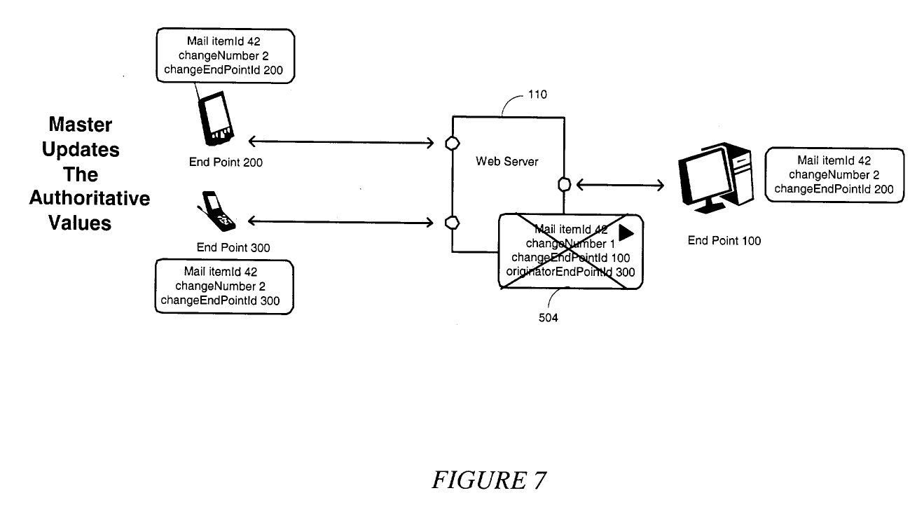

FIG. 6 shows when update requests 502, 504 have arrived at the web server 110, with update request 502 from End Point 200 arriving first. Since the Change_Number, e.g., 1, and Change-End-Point-Id, e.g., 100, in update request 502 match the authoritative values, e.g., Change_Number and Change_End_Point_Id, at the end point 100, end point 100 accepts the update request 502 and changes its authoritative Change_Number and Change_End_Point_Id to reflect that end point 200 was the last endpoint that changed the Mail item, as shown in FIG. 7. The subsequently arrived update request 504 from end point 300 is discarded since its Change_Number, e.g., 1, and Change_End_Point_Id, e.g., 100, no longer match the new authoritative values of Change_Number of 2 and Change_End_Point_Id of 200 at the end point 100.

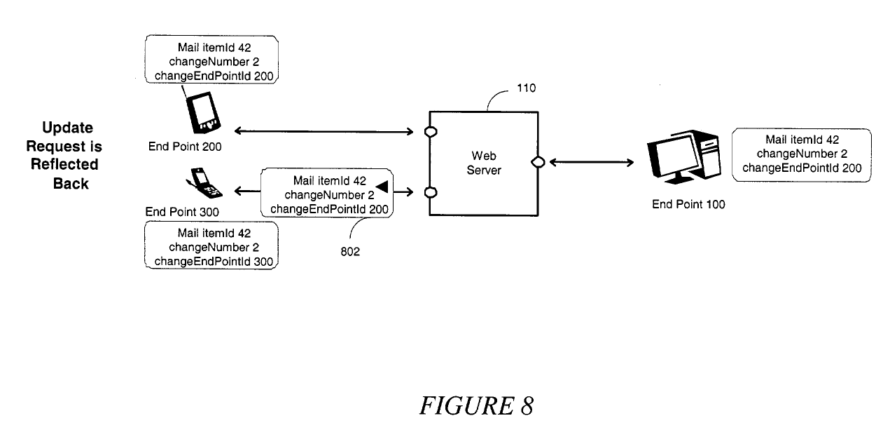

After the change that was originated by end point 200 is reflected at the endpoint 100, the other endpoint(s), in this case end point 300, is updated so that all end points end up in the same final state. FIG. 8 shows that an update request 802 containing the new authoritative values, e.g., “Change₁₃ Number 2,” and “Change-End-Point-Id 200,” is propagated back to the remaining end point(s), in this case end point 300.

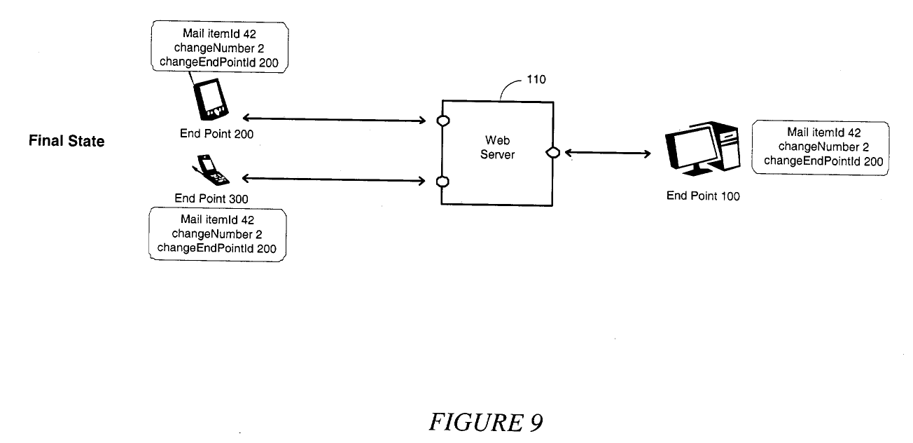

FIG. 9 shows that end point 300 has received the update request 802 from the master and has accepted the update request 802, because it is assumed that the master always wins. End point 300 updates its Change_Number and Change_End_Point_Id to reflect the new authoritative values, e.g., “Change_Number 2,” and “Change-End-Point-Id 200,” which are received from the master.

Therefore, the disclosed embodiments provide for a significant improvement in remote access of information in a global network. The disclosed methods and apparatus also provide for ensuring that all end points have the same final state after a change in an item of information occurs.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed embodiments is provided to enable any person skilled in the art to make or use the present invention. Various modifications to these embodiments may be readily apparent to those skilled in the art, and the generic principles defined herein may be applied to other embodiments, e.g., in an instant messaging service or any general wireless data communication applications, without departing from the spirit or scope of the invention. Thus, the present invention is not intended to be limited to the embodiments shown herein but is to be accorded the widest scope consistent with the principles and novel features disclosed herein. The word “exemplary” is used exclusively herein to mean “serving as an example, instance, or illustration.”

1. A method for providing information from a plurality of origin endpoints to a destination endpoint, the method comprising:
receiving information from a first origin endpoint, the information identifying the first origin end point, a version of the information at the first origin endpoint, and an endpoint that last changed the information;
receiving information from at least one second origin endpoint, the information identifying the second origin end point, a version of the information at the second origin endpoint, and an endpoint that last changed the information;
forwarding information received first from either the first origin endpoint or the second origin endpoint to the destination endpoint; and
updating a version of the information and an endpoint that last changed the information at the destination endpoint, based on the information that is forwarded to the destination endpoint.

2. The method of claim 1, further including blocking information that is received subsequent to the information received first from reaching the destination endpoint.

3. The method of claim 1, further including:
updating a version of the information and an endpoint that last changed the information at the endpoint whose information was received subsequent to the information received first, such that the first endpoint, the second endpoint, and the destination endpoint have a same version of the information and a same endpoint that last changed the information.

4. A computer-readable medium embodying a method for providing information from a plurality of origin endpoints to a destination endpoint, the method comprising:
receiving information from a first origin endpoint, the information identifying the first origin end point, a version of the information at the first origin endpoint, and an endpoint that last changed the information;
receiving information from at least one second origin endpoint, the information identifying the second origin end point, a version of the information at the second origin endpoint, and an endpoint that last changed the information;
forwarding information received first from either the first origin endpoint or the second origin endpoint to the destination endpoint; and
updating a version of the information and an endpoint that last changed the information at the destination endpoint, based on the information that is forwarded to the destination endpoint.

5. The computer-readable medium of claim 4, the method further including blocking information that is received subsequent to the information received first from reaching the destination endpoint.

6. The computer-readable medium of claim 4, the method further including:
updating a version of the information and an endpoint that last changed the information at the endpoint whose information was received subsequent to the information received first, such that the first endpoint, the second endpoint, and the destination endpoint have a same version of the information and a same endpoint that last changed the information.

7. An apparatus for providing information from a plurality of origin endpoints to a destination endpoint, comprising:
means for receiving information from a first origin endpoint, the information identifying the first origin end point, a version of the information at the first origin endpoint, and an endpoint that last changed the information;
means for receiving information from at least one second origin endpoint, the information identifying the second origin end point, a version of the information at the second origin endpoint, and an endpoint that last changed the information;
means for forwarding information received first from either the first origin endpoint or the second origin endpoint to the destination endpoint; and
means for updating a version of the information and an endpoint that last changed the information at the destination endpoint, based on the information that is forwarded to the destination endpoint.

8. The apparatus of claim 7, further including means for blocking information that is received subsequent to the information received first from reaching the destination endpoint.

9. The apparatus of claim 7, further including:
means for updating a version of the information and an endpoint that last changed the information at the endpoint whose information was received subsequent to the information received first, such that the first endpoint, the second endpoint, and the destination endpoint have a same version of the information and a same endpoint that last changed the information.

10. An apparatus for providing information from a plurality of origin endpoints to a destination endpoint, comprising:
a receiver capable of receiving information from a remote access device;
a transmitter capable of transmitting information to the remote access device; and
a processor capable of carrying out a method, the method comprising:
receiving information from a first origin endpoint, the information identifying the first origin end point, a version of the information at the first origin endpoint, and an endpoint that last changed the information;
receiving information from at least one second origin endpoint, the information identifying the second origin end point, a version of the information at the second origin endpoint, and an endpoint that last changed the information;
forwarding information received first from either the first origin endpoint or the second origin endpoint to the destination endpoint; and
updating a version of the information and an endpoint that last changed the information at the destination endpoint, based on the information that is forwarded to the destination endpoint.

11. The apparatus of claim 10, the method further including blocking information that is received subsequent to the information received first from reaching the destination endpoint.

12. The apparatus of claim 10, the method further including:
updating a version of the information and an endpoint that last changed the information at the endpoint whose information was received subsequent to the information received first, such that the first endpoint, the second endpoint, and the destination endpoint have a same version of the information and a same endpoint that last changed the information.

13. A method for providing information to one of a plurality of access devices, the method comprising:
receiving a request for the information from one of the plurality of access devices;
delivering the information to the one of the plurality of access devices, if the information is available in a format suitable for delivery to the one of the plurality of the access devices;
accessing the information from a destination endpoint, if the information is unavailable;
transforming the received information to a format suitable for delivery to the one of the plurality of the access devices; and
delivering the information to the one of the plurality of access devices.

14. The method of claim 13, further including queuing the transformed information for delivery to the one of the plurality of the access devices.

15. A computer-readable medium embodying a method for providing information to one of a plurality of access devices, the method comprising:
receiving a request for the information from one of the plurality of access devices;
delivering the information to the one of the plurality of access devices, if the information is available in a format suitable for delivery to the one of the plurality of the access devices;
accessing the information from a destination endpoint, if the information is unavailable;
transforming the received information to a format suitable for delivery to the one of the plurality of the access devices; and
delivering the information to the one of the plurality of access devices.

16. The computer-readable medium of claim 15, the method further including queuing the transformed information for delivery to the one of the plurality of the access devices.

17. An apparatus for providing information to one of a plurality of access devices, comprising:
means for receiving a request for the information from one of the plurality of access devices;
means for delivering the information to the one of the plurality of access devices, if the information is available in a format suitable for delivery to the one of the plurality of the access devices;
means for accessing the information from a destination endpoint, if the information is unavailable;
means for transforming the received information to a format suitable for delivery to the one of the plurality of the access devices; and
means for delivering the information to the one of the plurality of access devices.

18. The apparatus of claim 17, further including means for queuing the transformed information for delivery to the one of the plurality of the access devices.

19. An apparatus for providing information to one of a plurality of access devices, comprising:
a receiver capable of receiving information from a remote access device;
a transmitter capable of transmitting information to the remote access device; and
a processor capable of carrying out a method, the method comprising:
receiving a request for the information from one of the plurality of access devices;
delivering the information to the one of the plurality of access devices, if the information is available in a format suitable for delivery to the one of the plurality of the access devices;
accessing the information from a destination endpoint, if the information is unavailable;
transforming the received information to a format suitable for delivery to the one of the plurality of the access devices; and
delivering the information to the one of the plurality of access devices.

20. The apparatus of claim 19, the method further including queuing the transformed information for delivery to the one of the plurality of the access devices.

21. A method for providing information to one of a plurality of access devices, the method comprising:
accessing the information from an endpoint;
transforming the information into a plurality of formats, each format suitable for delivery to one of the plurality of access devices; and
delivering the transformed information to one of the plurality of access devices, if the one of the plurality of access devices is ready to receive the transformed information; and
queuing the transformed information, if the one of the plurality of access devices is not ready to receive the transformed information.

22. A computer-readable medium embodying a for providing information to one of a plurality of access devices, the method comprising:
accessing the information from an endpoint;
transforming the information into a plurality of formats, each format suitable for delivery to one of the plurality of access devices; and
delivering the transformed information to one of the plurality of access devices, if the one of the plurality of access devices is ready to receive the transformed information; and
queuing the transformed information, if the one of the plurality of access devices is not ready to receive the transformed information.

23. An apparatus for providing information to one of a plurality of access devices, comprising:
means for accessing the information from an endpoint;
means for transforming the information into a plurality of formats, each format suitable for delivery to one of the plurality of access devices; and
means for delivering the transformed information to one of the plurality of access devices, if the one of the plurality of access devices is ready to receive the transformed information; and
means for queuing the transformed information, if the one of the plurality of access devices is not ready to receive the transformed information.

24. An apparatus for providing information to one of a plurality of access devices, comprising:
a receiver capable of receiving information from a remote access device;
a transmitter capable of transmitting information to the remote access device; and
a processor capable of carrying out a method, the method comprising:
accessing the information from an endpoint;
transforming the information into a plurality of formats, each format suitable for delivery to one of the plurality of access devices; and
delivering the transformed information to one of the plurality of access devices, if the one of the plurality of access devices is ready to receive the transformed information; and
queuing the transformed information, if the one of the plurality of access devices is not ready to receive the transformed information.

25. An apparatus for providing information from one of a plurality of applications to one of a plurality of remote access devices, comprising:
a plurality of protocol adapters each capable of receiving a request from one of the plurality of remote access devices;
a web server, communicatively coupled with the plurality of the protocol adapters and the plurality of applications, the web server being capable of:
receiving device-irrelevant information from one of the plurality of applications; and
transforming the received device-irrelevant information to a plurality of device-relevant formats, each device-relevant format suitable for delivery to one of the plurality of remote access devices, so that each one of the plurality of the protocol adapters receives the one of the device-relevant formats and provides it to the corresponding one of the plurality of remote access devices.

26. The apparatus of claim 15, wherein the plurality of protocol adapters and the plurality of applications communicate with the web service through a simple object access protocol (SOAP).

27. The apparatus of claim 25, wherein the web server queues the received device-relevant formats for delivery to the plurality of remote access devices.

28. An apparatus for providing information from one of a plurality of applications to one of a plurality of remote access devices, comprising:
means for receiving device-irrelevant information from one of the plurality of applications; and
means for transforming the received device-irrelevant information to a plurality of device-relevant formats, each device-relevant format suitable for delivery to one of the plurality of remote access devices; and
means for queuing the received device-relevant formats for delivery to the plurality of remote access devices.
